(19) United States
(12) Patent Application Publication
(10) Pub. No.: US 2011/0063563 A1
(43) Pub. Date: Mar. 17, 2011

(54) Fast response twisted nematic liquid crystal display and method

(75) Inventors: Li Yan Long, Shenzhen (CN); Sun Yu Bao, Shenzhen (CN)

(73) Assignee: SHENZHEN AV-DISPLAY CO., LTD., Shenzhen (CN)

(21) Appl. No.: 12/807,910

(22) Filed: Sep. 15, 2010

(30) Foreign Application Priority Data
Sep. 15, 2009 (CN) 200910176443.5

(51) Int. Cl. G02F 1/1333; C23F 1/00

(52) U.S. Cl. 349/159; 216/17

(57) ABSTRACT

A Twisted Nematic Liquid Crystal Display (TN-LCD for short below) with fast response time includes polarizer, glass substrates, indium tin oxide (ITO) electrodes, alignment layers, liquid crystal material, sealing material, spacers. The TN-LCD employs a method of improving its response time that can improve color saturation of the field sequential LCD or the response time of the optical shutter.

### CROSS REFERENCE TO RELATED APPLICATIONS

The present application claims priority and incorporates by reference in its entirety Chinese Patent Application No. CN 200910176443.5 filed Sep. 15, 2009.

### TECHNICAL FIELD

Embodiments of the present disclosure relate to a fast response Twisted Nematic Liquid Crystal Display (TN-LCD) and a method of manufacture that improves response time.

### BACKGROUND

For normal TN-LCD, the typical response time is longer than 5˜10 milliseconds. Thus it can not match the requirement of Field Sequential LCD and optical shutter. As for Optically Compensated Bend LCD, (OCB for short), a bias voltage is involved to obtain the bend state of liquid crystal. This will make driving the circuit more complex and the power consumption higher.

### SUMMARY OF INVENTION

The aim of the invention is to improve the response time, especially the fall time, of normal TN-LCD. The invention also provides a method of improving the response time of TN-LCD.

The invention employs a normal TN-LCD cell, by reducing the thickness of liquid crystal layer and adjusting the helical pitch of liquid crystal material, to obtain fast response time shorter than 3 milliseconds. The invention can improve the color saturation of Field Sequential LCD and the response time of optical shutter.

A fast response TN-LCD comprises polarizer, glass substrate, ITO electrode, alignment layer, liquid crystal material, sealing material, spacers. Wherein the polarizer, glass substrate, ITO electrode, alignment layer are disposed layer by layer; In between two alignment layers, spacer is dispersed evenly to maintain a cell gap. Liquid crystal material is filled inside the gap.

Two related polarizers are attached to the outside surface of both glass substrates.

The related glass substrate is coated with ITO pattern and alignment layer on the inner surface.

The related glass substrate, ITO electrode, alignment layer are set one after another. Liquid crystal material is aligned along the rubbing direction inside the cell.

Two related glass substrates are conglutinated by sealing material. Inside them, spacers are dispersed evenly to maintain the cell gap.

The related sealing material is printed like a closed loop in between two glass substrates which is close to margin of glass substrates. Only a small entrance is left for liquid crystal filling. The printed sealing frame and glass substrates form a hermetic space.

The related alignment layer, which rubbing direction is parallel to the axis of nearby polarizer, is rubbed to form the pre-tilt angle of 1 to 8 degrees.

To the related fast response TN-LCD, wherein the thickness of liquid crystal layer varies from 2 micron to 3 micron, d/p ratio varies from 0.2 to 0.5. Wherein d is the thickness of liquid crystal layer and p is helical pitch of liquid crystal material (unit: micron).

To the related fast response TN-LCD, wherein the product of the thickness of liquid crystal material layer and the birefringence index of liquid crystal material is set to 400 nm-600 nm.

The manufacture method of fast response TN-LCD is as follows:
Step 1, etch to form the electrode pattern;
Step 2, coat and cure alignment layer;
Step 3, rubbing of alignment layer;
Step 4, spray spacer and print seal material;
Step 5, assemble both of glass substrates and cure seal material;
Step 6, cut mother glass into separate LCD cell;
Step 7, fill liquid crystal and seal end; and
Step 8, clear surface and attach polarizer.

Compared with the normal TN-LCD, some improvements of the invention are as follows: By increasing the content of chiral dopant in liquid material and using small cell gap and liquid crystal material with large birefringence index, the response time of TN-LCD is improved. Thus it can match the requirement of Field Sequential LCD and optical shutter.

The related TN-LCD exhibits the feature of fast response. It employs normal TN-LCD cell, which twist angle is 90 degree. The invention can improve the color saturation of Field Sequential LCD and the response time of optical shutter.

### BRIEF DESCRIPTION OF THE DRAWINGS

Non-limiting and non-exhaustive exemplary embodiments of the present disclosure are described with reference to the following drawings in which:

FIG. 1A illustrates a side cross-sectional view of the related fast response TN-LCD in accordance with at least one embodiment;

FIG. 1B illustrates a top plan view of the related fast response TN-LCD in accordance with at least one embodiment;

FIG. 2 is a graph diagram view illustrating the relationship between response time and d/p ratio of the related fast response TN-LCD in accordance with at least one embodiment;

FIG. 3 is a graph diagram view illustrating fall time curves with different d/p ratio of the related fast response TN-LCD in accordance with at least one embodiment;

FIG. 4 illustrates a graphical block diagram view of portions of a user interface of a Field Sequential LCD module in which the related fast response TN-LCD is being used in accordance with at least one embodiment;

FIGS. 5A-5F illustrate side cross-sectional views of a method of manufacture of the fast response TN-LCD in accordance with at least one embodiment; and

FIG. 6 illustrates a flow diagram of the manufacturing process in accordance with at least one embodiment.

### DETAILED DESCRIPTION

In the following detailed description, reference is made to the accompanying drawings which form a part hereof wherein like numerals designate like parts throughout, and in which are shown, by way of illustration, specific embodiments in which the disclosure may be practiced. It is to be understood that other embodiments may be utilized and structural or logical changes may be made without departing from the scope of the present disclosure. Therefore, the following detailed description is not to be taken in a limiting sense, and the scope of a portion of the present disclosure is defined by the appended claims and their equivalents.

Throughout the specification and claims, the following terms take at least the meanings explicitly associated herein, unless the context clearly dictates otherwise. The meanings identified below are not intended to limit the terms, but merely provide illustrative examples for use of the terms. The meaning of “a,” “an,” and “the” may include reference to both the singular and the plural. Reference in the specification to “one embodiment” or “an embodiment” means that a particular feature, structure, or characteristic described in connection with the embodiment is included in at least one embodiment of the disclosure. The meaning of “in” may include “in” and “on.” The appearances of the phrases “in one embodiment” or “in an embodiment” in various places in the specification do not necessarily all refer to the same embodiment, but it may. The term “circuit” or “circuitry” as used in any embodiment described herein, can mean a single component or a plurality of components, active and/or passive, discrete or integrated, that are coupled together to provide a desired function and may include, for example, singly or in any combination, hardwired circuitry, programmable circuitry, state machine circuitry, and/or firmware that stores instructions executed by programmable circuitry.

In an effort to clarify comparative phrases used in the specification and the claims of this disclosure, please note that the following phrases take at least the meanings indicated and associated herein, unless the context clearly dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(A B) or (B)”, that is “A” is optional.

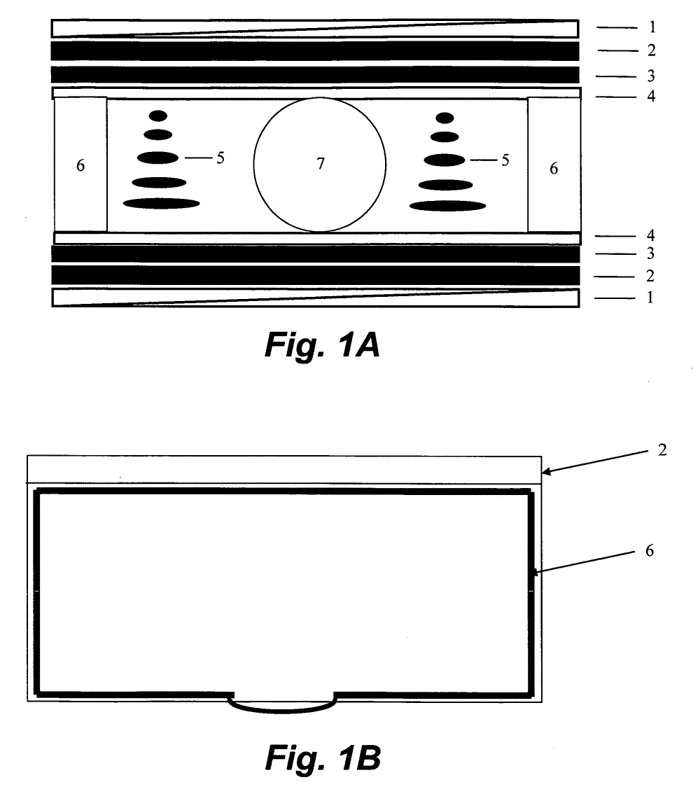

Referring now to FIG. 1A, a side cross-sectional view of the related fast response TN-LCD is shown in accordance with various embodiments of the present disclosure. The fast response TN-LCD comprises polarizer (1), glass substrate (2), ITO electrode (3), alignment layer (4), liquid crystal material (5), sealing material (6), spacers (7). Wherein the polarizer (1), glass substrate (2), ITO electrode (3), alignment layer (4) are disposed layer by layer. In between two alignment layers, spacer (7) is dispersed evenly to maintain a cell gap. Liquid crystal material (5) is filled inside the cell gap.

Two polarizers(1) are attached to the outside surface of both glass substrates(2). Glass substrate (2) is coated with ITO pattern (3) and alignment layer (4) on the inner surface. The glass substrate (2), ITO electrode (3), alignment layer (4) are set one after another. Inside the cell, liquid crystal material (5) is aligned along the rubbing direction. Two glass substrates (2) are conglutinated by sealing material (6). FIG. 1B shows a top plan view the top glass substrate (2) and sealing material (6) of the related fast response TN-LCD. Inside the two glass substrates (2) conglutinated by the sealing material (6), spacers (7) are dispersed evenly to maintain the cell gap.

The alignment layer (4), which rubbing direction is parallel to the axis of nearby polarizer, is rubbed to form the pre-tilt angle of 1 to 8 degree. The product of the thickness of liquid crystal layer and the birefringence index of liquid crystal material is set to be 400 nm˜600 nm to ensure a higher transmittance ratio. Assuming the driving voltage is 0V for bright state and 9V for dark state respectively, by varying the thickness of liquid crystal layer and the helical pitch of liquid crystal material, a series of response time data is obtained, as shown in Table A.

Table A is computer simulation results of response time with different liquid crystal layer thickness and different d/p ratio. Tr is rise time, which the transmittance ratio varies from 90% to 10% after the additional voltage is applied. The unit of rise time is millisecond. Tf is fall time, which the transmittance ratio varies from 10% to 90% after the additional voltage is removed. The unit of fall time is millisecond.

TABLE A

| | Pitch | | Tr (ms) | Tf (ms) |
|---|---|---|---|---|
| d (um) | (um) | d/p | (10%~90%) | (10%~90%) |
| 3 | 6.67 | 0.45 | 0.757 | 2.683 |
| 3 | 12 | 0.25 | 0.801 | 3.172 |
| 3 | 30 | 0.10 | 0.817 | 3.663 |
| 3 | 60 | 0.05 | 0.819 | 3.85 |
| 2.5 | 5.6 | 0.446 | 0.442 | 2.03 |
| 2.5 | 10 | 0.25 | 0.436 | 2.383 |
| 2.5 | 25 | 0.10 | 0.436 | 2.753 |
| 2.5 | 50 | 0.05 | 0.437 | 2.923 |
| 2 | 4.44 | 0.45 | 0.794 | 1.759 |
| 2 | 8.0 | 0.25 | 0.761 | 2.041 |
| 2 | 20 | 0.10 | 0.713 | 2.448 |
| 2 | 40 | 0.05 | 0.689 | 2.50 |

The data results in Table A show that the fall time becomes shorter than 3 ms while the thickness of liquid crystal layer is 3 um and d/p ratio is set to be 0.25. Reducing the thickness of liquid crystal layer further will lead to shorter response time.

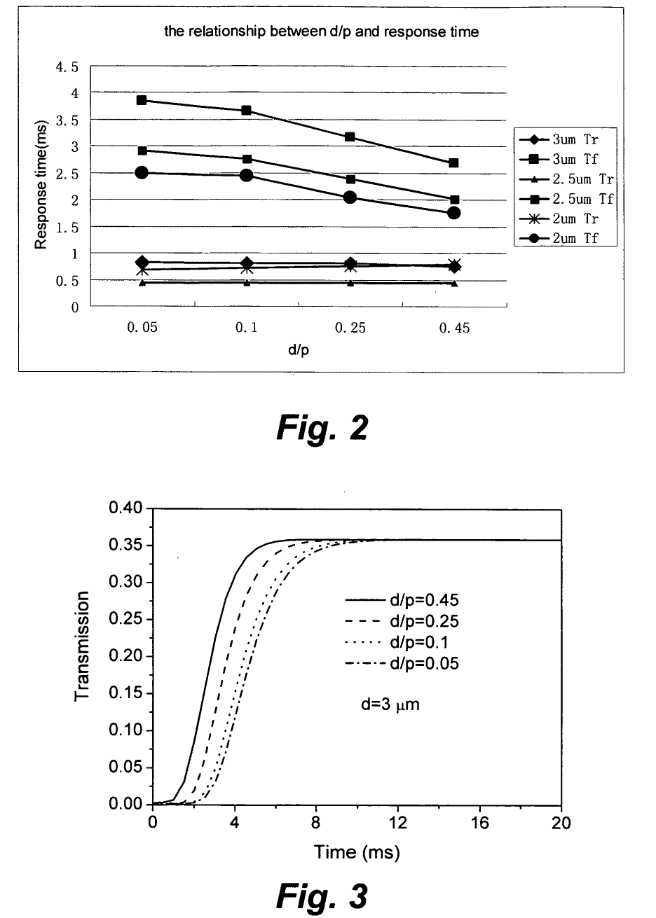

Referring to FIG. 2, a graph diagram view shows the relationship between response time and d/p ratio of the related fast response TN-LCD in accordance with at least one embodiment. As shown in FIG. 2, while the thickness of liquid crystal layer being fixed, the helical pitch being reduced or d/p ratio being increased, rise time Tr varies a little and the fall time Tf reduces remarkably.

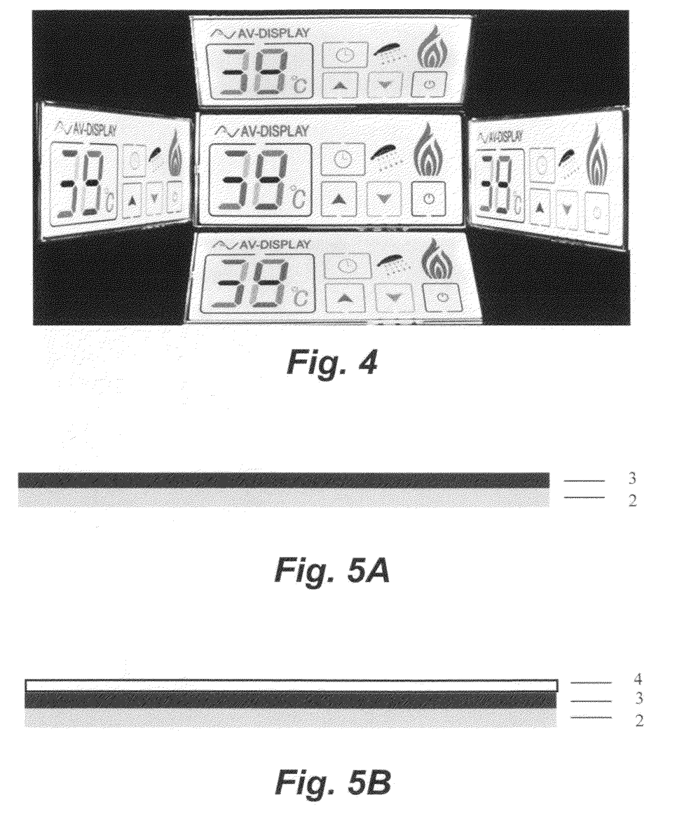

Referring to FIG. 3, a graph diagram view shows fall time curves with different d/p ratio of the related fast response TN-LCD in accordance with at least one embodiment. FIG. 3 illustrate fall time curves with different d/p ratio of the related fast response TN-LCD. The thickness of liquid crystal layer is 3 um. Different curves correspond to different d/p ratios respectively. Horizontal axis is the time axis, and vertical axis is transmittance ratio accordingly. The driving voltage is removed at time zero. Curves show the change of transmittance ratio after driving voltage being removed.

If the delay time is considered while transmittance ratio increasing, as shown in FIG. 3, the reducing of total fall time will be more significant. By reducing the thickness of liquid crystal layer to 2 um˜3 um and setting d/p ratio to 0.2˜0.5, the response time can be within Tr 1.5 ms and Tf 3 ms.

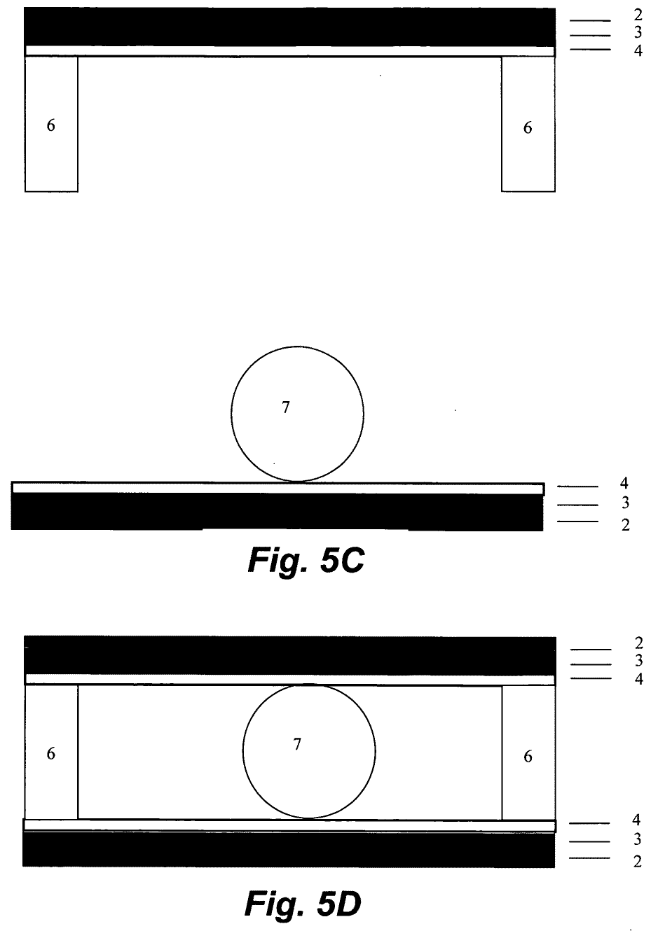

Referring now to FIG. 4, a graphical block diagram view shows portions of a user interface of a Field Sequential. LCD module in which the related fast response TN-LCD is being used in accordance with at least one embodiment. FIG. 4 represents the Field Sequential LCD module taken from five directions, including head on, left, right, up and down. The actual parameters of one embodiment of the liquid crystal cell are as follows:
Thickness of liquid crystal layer: 3.0 um,
Helical pitch of liquid crystal material: 6.7 um, (d/p=0.448),
Liquid crystal material: AVD11800-100 from JiangSu Hecheng Chemical Materials Co., Ltd.,
Measurement results of response time: Tr=1.5 ms, T3.0 ms.

A Field Sequential LCD module in which the related fast response TN-LCD is used, exhibits an excellent viewing cone as shown in FIG. 4.

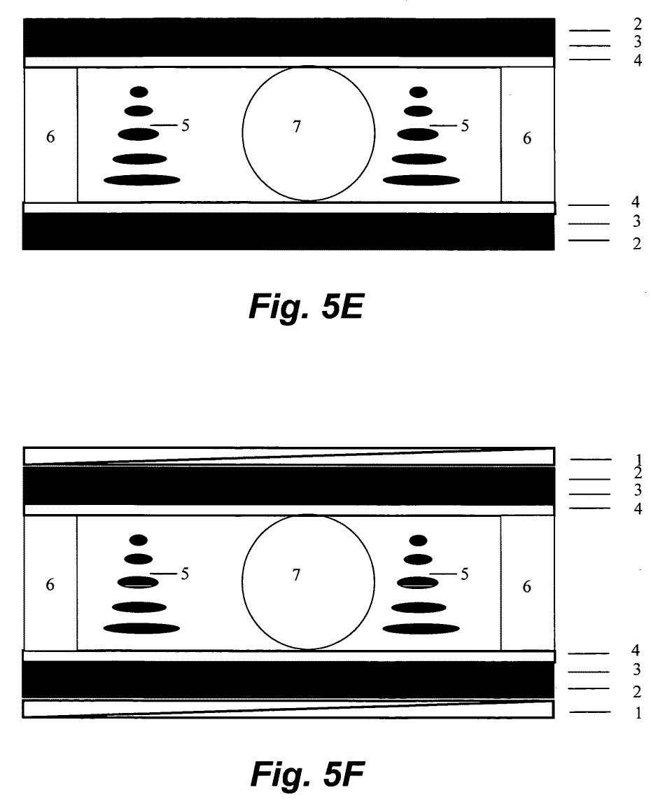

Referring now to FIGS. 5A-5F, side cross-sectional views of a method of manufacture of the fast response TN-LCD are shown in accordance with at least one embodiment. The manufacture process of the related fast response TN-LCD include the following steps. Step 1 etches to form the electrode pattern (see e.g., FIG. 5A). Step 2 coats and curing of alignment layer (see e.g., FIG. 5B). Step 3 rubbing of alignment layer (see e.g., FIG. 5B). Step 4 sprays spacer and prints seal material (see e.g., FIG. 5C). Step 5 assembles both of glass substrates and cures seal material (see e.g., FIG. 5D). Step 6 cuts mother glass into separate LCD cell (see e.g., FIG. 5D). Step 7 fills with liquid crystal filling and seals ends (see e.g., FIG. 5E). Step 8 clears surface and attaches polarizer (see e.g., FIG. 5F).

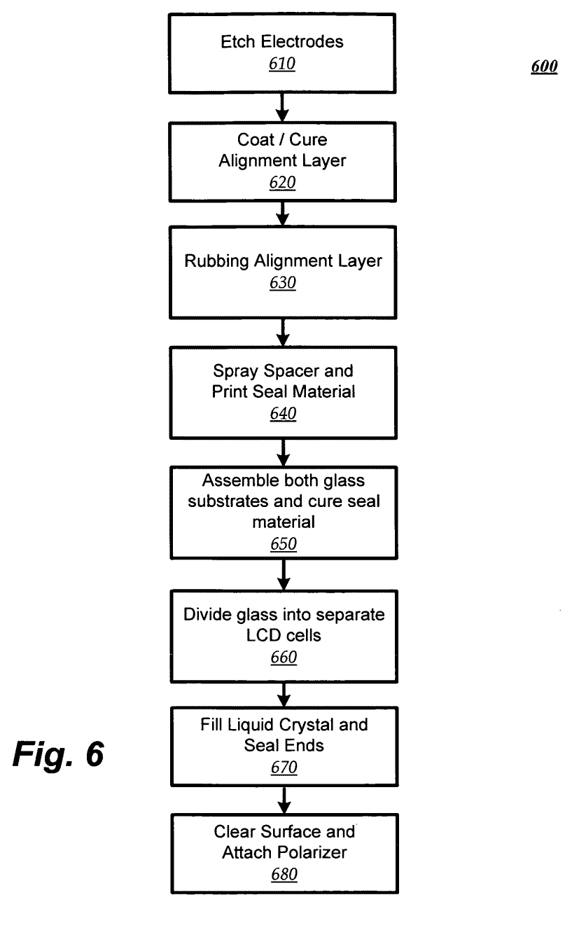

Referring now to FIG. 6, a flow diagram view of a portion of operations of a manufacture process 600 of the related fast response TN-LCD. The process 600 starts in block 610 by etching an electrode pattern similar to that shown in FIG. 5A. Upon completion of etching, the process 600 begins coating and curing of alignment layer in block 620 similar to that shown in FIG. 5B. The process 600 may also complete rubbing alignment layer in block 630. Upon completion of rubbing, the process 600 begins spraying spacer and print seal material in block 640 similar to that shown in FIG. 5C. Upon completion of spraying, the process 600 begins assembly of both glass substrates and cures seal materials in block 650 similar to that shown in FIG. 5D. Upon assembly and curing, the process 600 begins cutting the glass into separate LCD cells in block 660. Upon completion of separating into LCD cells, the process 600 begins filling liquid crystal and sealing the ends of each LCD cell in block 670 similar to that shown in FIG. 5E. Once filled and sealed, the process 600 begins clearing the surface and attaching polarizer in block 680 similar to that shown in FIG. 5F.

The above specification, examples and data provide a complete description of the manufacture and use of the composition of the invention. Although specific embodiments have been illustrated and described herein, it will be appreciated by those of ordinary skill in the art and others, that a wide variety of alternate and/or equivalent implementations may be substituted for the specific embodiment shown in the described without departing from the spirit and scope of the present disclosure. This application is intended to cover any adaptations or variations of the embodiments discussed herein. Therefore, it is manifested and intended that the disclosure be limited only by the claims and the equivalence thereof.

What is claimed is:

1. A Twisted Nematic Liquid Crystal Display (TN-LCD) with fast response time, comprising:
polarizer (1);
glass substrate (2);
ITO electrode (3);
alignment layer (4);
liquid crystal material (5);
sealing material (6); and
spacers (7) wherein the polarizer (1), glass substrate (2), ITO electrode (3), and alignment layer (4) are disposed layer by layer in between two alignment layers, spacers (7) are dispersed evenly to maintain a cell gap and liquid crystal material (5) is filled inside the cell gap.

2. The fast response TN-LCD of claim 1, wherein the polarizer (1) is attached to the outside surface of glass substrate (2).

3. The fast response TN-LCD of claim 1, wherein both the inner side of glass substrates (2) are ITO electrodes (3) and alignment layers (4).

4. The fast response TN-LCD of claim 1, wherein glass substrate (2), ITO electrode (3), alignment layer (4) are set one after another inside the cell, liquid crystal material (5) is aligned along the rubbing direction.

5. The fast response TN-LCD of claim 1, wherein the two glass substrates are conglutinated by sealing material (6) inside them, spacers (7) are dispersed evenly to maintain the cell gap.

6. The fast response TN-LCD of claim 1, wherein the sealing material is printed stripe-like in between the two glass substrates, close to the edge of glass substrate, to form a semi-closed loop. Thus a semi-hermetical space is formed together with the two glass substrates.

7. The fast response TN-LCD of claim 1, wherein the rubbing direction of alignment layer (4) is parallel with optical axis of polarizer (1) nearby and the pre-tilt angle of alignment layer (4) is 1 to 8 degree.

8. The fast response TN-LCD of claim 1, wherein the thickness of liquid crystal layer varies from 2 micron to 3 micron, d/p ratio varies from 0.2 to 0.5 and wherein d is the thickness of liquid crystal layer and p is helical pitch of liquid crystal material (unit: micron).

9. The fast response TN-LCD of claim 1, wherein the product of the thickness of liquid crystal layer and the birefringence index of liquid crystal is set to 400 nm˜600 nm.

10. The method of manufacturing a fast response TN-LCD of claim 1 comprises the steps of
Step 1 etch to form the electrode pattern;
Step 2 coat and cure of alignment layer;
Step 3 rubbing of alignment layer;
Step 4 spray spacer and print seal material;
Step 5 assemble both of glass substrates and cure seal material;
Step 6 cut mother glass into separate LCD cell;
Step 7 pouring Liquid crystal filling and sealing ends; and
Step 8 rinsing surface clear and attaching polarizer.
